(19) United States
(12) Patent Application Publication
(10) Pub. No.: US 2021/0084014 A1
(43) Pub. Date: Mar. 18, 2021

(54) VIRTUALIZED CENTRALIZED FIREWALL

(71) Applicant: Srinivas KOLA, Milpitas, CA (US)

(72) Inventor: Srinivas KOLA, Milpitas, CA (US)

(21) Appl. No.: 17/022,045

(22) Filed: Sep. 15, 2020

Related U.S. Application Data
(60) Provisional application No. 62/900,831, filed on Sep. 16, 2019.

(51) Int. Cl. H04L 29/06

(52) U.S. Cl. CPC H04L 63/0263; H04L 63/20

(57) ABSTRACT

This innovative apparatus and method called the Virtualized Centralized Firewall (VCF), with its hardware and software provides a means for Security and Firewall services at line speed for internet connections to several users, homes and enterprises at the same time from a centralized location like the ISP, Telephone Central office (for DSL), the Cable headend, 5G/LTE edge networks or similar locations. The resources in this VCF are shared by multiple users based on pre-subscribed bandwidth and types of security services. These services can be controlled by the end user by self-service or by the operator or a combination of both. This results in efficient usage of resources, lower cost (about 90% cost reduction) and more importantly provide a fast and efficient way to update the security profiles for virus scans and protect end users and IoT devices against new types of cyber-attacks.

### BACKGROUND OF THE INVENTION

A firewall is a network security device that establishes a barrier between a trusted internal network and an untrusted external network. The firewall will reside at the entry point of the trusted network (home, office or Enterprise networks) and establishes a barrier between the trusted internal network and the Internet. In computer networking and communications, the firewall provides network security by monitoring and controlling the incoming and outgoing network traffic based on predetermined or preconfigured security rules.

With the internet becoming a critical resource, required 24/7 by all and with the rising sophistication of Spam and Cyber-attacks, internet security has become one of the key areas of concern for users to realize the full potential of the Internet. In order to handle these issues having a security software like a Virus scanner is recommended on the PC/laptop or end user devices. In addition, it is necessary to have a security tool like a firewall at the network entry point along with the home/SMB router or the Enterprise router to protect the entire network including end devices (including PCs with or without virus scanner) and the proliferating Internet of Things (IoT) devices. Most of these IoT devices have no security, becoming a new target for cyber-tampering, allowing hackers to intrude into homes and offices digitally.

The solutions available now have a Firewall at network entry point into the premises for intrusion detection and protection, reduce requirements for end-point virus scan, protect unprotected devices like IoT etc. Virus scan on end point devices (PCs/laptops etc) is a CPU burden slowing them down.

### BRIEF DESCRIPTION OF THE DRAWINGS

FIG. 1(a) shows firewalls at the entry to end user networks in accordance with the prior art. FIG. 1(b) is a schematic of a cloud-managed firewall. FIG. 1(c) shows an ISP-managed virtualized and centralized firewall.

FIG. 2 is a representation of a virtualized centralized firewall system for a number n of end users.

FIG. 3(a) is a schematic diagram of a virtualized centralized firewall system for a cable or fiber ISP. FIG. 3(b) is a schematic diagram of a virtualized centralized firewall system for a Digital Subscriber Line (DSL) ISP or an Asymmetric Digital Subscriber Line (ADSL) ISP. FIG. 3(c) is a schematic diagram of a virtualized centralized firewall system for affixed wireless system (LTE, 4G, 5G, etc.).

FIG. 4 is a flow-diagram for provisioning services using a virtualized centralized firewall system.

### GLOSSARY FOR FIGURES

CMTS Cable Modem Termination Unit

C.O. Telco Central office (also written as CO)

DSL Digital Subscriber Line

DSLAM Digital Subscriber Line Access Multiplexer

FW Firewall

No FW No Firewall present

IoT Internet of Things

ISP Internet Service Provider

Mgt Management

OLT Optical Line Termination

ONU Optical Network Unit

R Router (in the figures)

VCF Virtualized Centralized Firewall

### DETAILED DESCRIPTION

The two typical Firewall use cases are:

Case-1: Standard

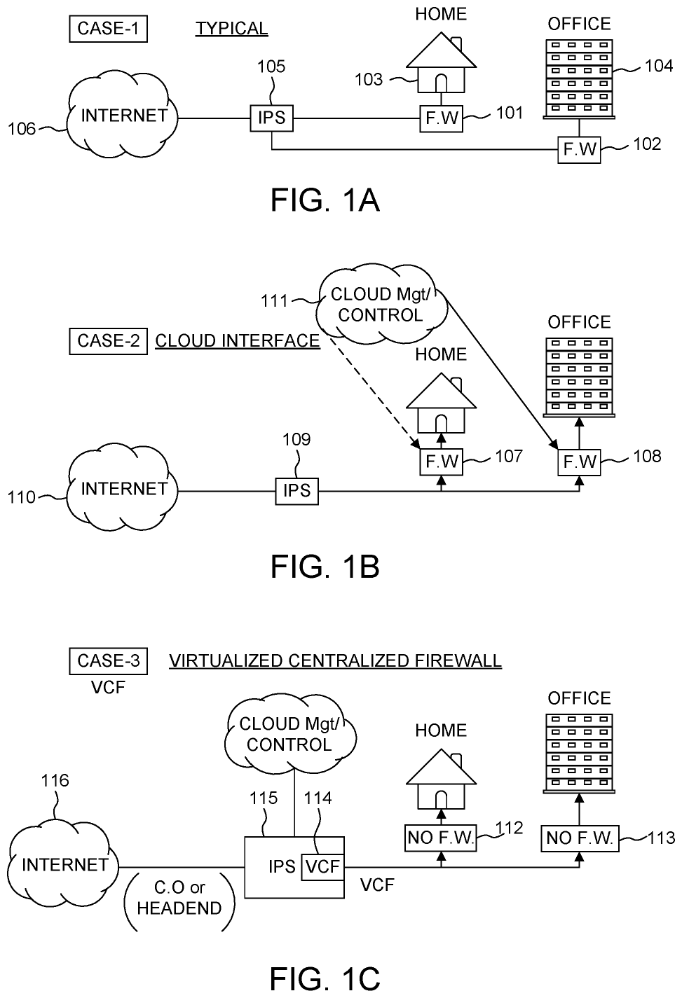

This case is shown in FIG. 1(a). The Firewall (FW) (101 and 102) is located at the entry point of end user network like home (103) or SMB/Office/Enterprise (104) that needs to be protected. This needs manual download of upgrades.

Case-2: Cloud Interface for Management/Control

The Cloud managed Firewall is shown in FIG. 1(b). The Firewall (107) is connected to the cloud-based Management/Control (111). End-user can setup account and manage the virus profile downloads manually or automatically as in FIG. 1(b)

This patent application deals with a new implementation which is show as in FIG. 1(c).

Case-3: Virtualized & Centralized Firewall (Invention & Novel Apparatus)

All the Firewalls in the end-user networks in individual Homes (112), SMBs and Enterprises (113) connected to the ISP (115) are absorbed into one system and implemented in one central location inside the ISP as Virtualized Centralized Firewall (VCF) (114) with novel features and capabilities as shown in Case-3 in FIG. 1(c). This invention and novel apparatus and its features will be described in greater detail in the rest of the patent application.

Firewall—Virtualized & Centralized (Invention)

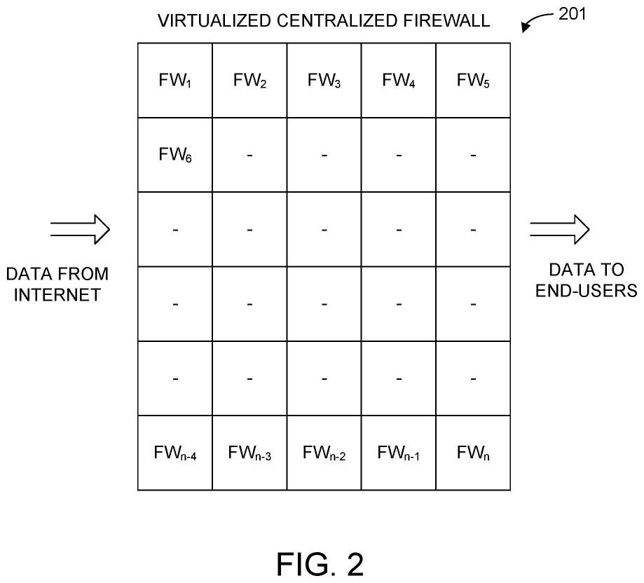

The invention provides an apparatus and method for the Virtualization and Centralization of Security Firewall The Firewalls in the homes, SMBs and Offices are absorbed into a central location and combined and implemented as one large system as shown in FIG. 1(c). The concept of Virtualized and Centralized Firewall (201) is shown in FIG. 2, where “n” end user Firewalls (FWs) are centralized into one large Firewall. The resources of this central system are shared between users based on demand. The processing power, virus scanning resources, intrusion detection resources and other security features are shared across many users. Data privacy is maintained. As the demand increases, more powerful Firewall can be installed, or additional Firewalls added in parallel to make a larger system. This large Firewall system can be configured to handle the firewall/security needs of all, or a subset of all the homes, SMB's, offices and enterprises connected to it. It can be located in the ISP, Telco Central Office, Headend or Nodes in a cable network, wiring cabinets on street side for DSL or Fiber networks etc., but not limited to these locations or access technologies. Hence it is a virtualized and centralized Firewall to end users.

Implementation Diagram:

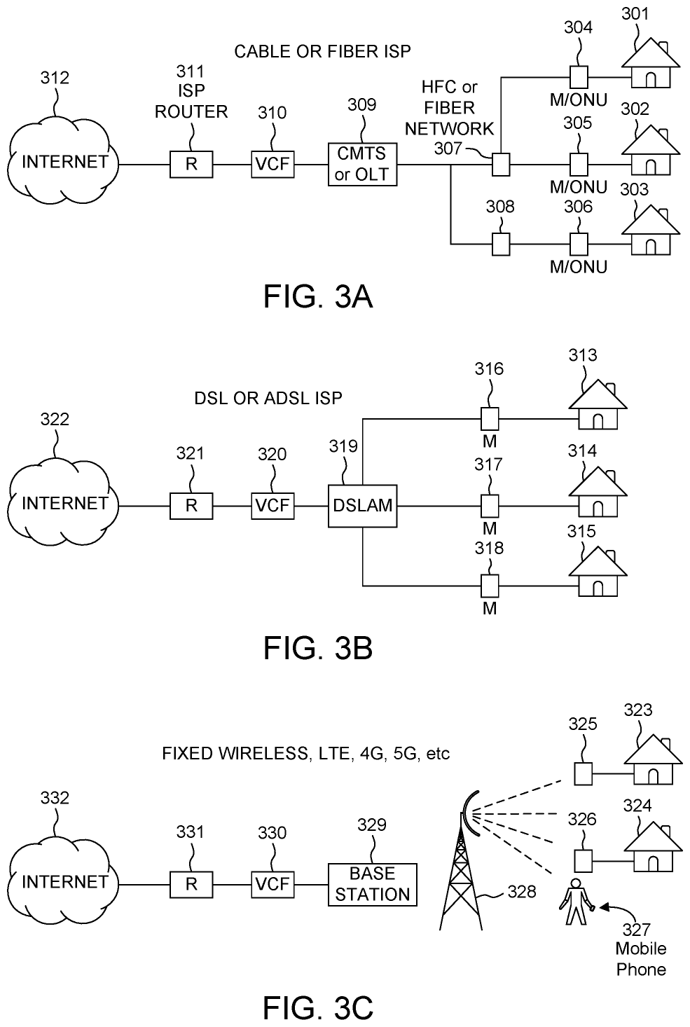

The VCF can be used in front of the media access devices for any broadband access technology as shown in FIG. 3. A media access device enables the Ethernet packets from Internet side to be transmitted and received from end users over the medium provided by the broadband technology like cable, fiber, DSL, wireless etc. For Cable networks and PON based fiber networks, the distribution side architecture is very similar, except for the different medium (Cable or Fiber) that is used. In the case of DSL with DSLAM, the distribution side is a switched network with individual connections to each user. When the firewall is moved from the end user network to the centralized location the security for the traffic between these two points must be confirmed. Referring to FIG. 3(a), for Cable data based on DOCSIS standard, there is already encryption of data between the CMTS (309) and the modems (304, 305 and 306) that are located in the end-user network. Similarly, for PON based fiber networks the connection between OLT (309) in the service provider office to ONU (304, 305 & 306) in the end user network is secured. For switched networks like DSL the connection between DSLAM (319) and the modem (316, 317 & 318) in end user network is a dedicated line and hence with no security concerns. Hence, line security is not compromised in providing Centralized Firewall service in a typical broadband network. In the case the Firewall is located more interior to the ISP, then the ISP must provide appropriate security for the connection between the firewall and the media access device. In the case of 5G/4G/LTE environment as shown in FIG. 3(c), the VCF (330) still provides security from internet based threats, but the wireless link between wireless tower (328) and the end user modems (325, 326) and to mobile phone (327) has to be secured by the service provider with any of the technologies available for such links, irrespective of whether the VCF is present or not. Providing a secure link between service provider office (CO or Headend etc) and the end user is typically expected from the ISP.

Multi-Use:

This is a universal product that can be used for Broadband and any other network application including the enterprise. In the enterprise case it will allow security behavior to be tracked and managed to an individual user or device, enabling quick identification of infected machines and any other potential threats. This apparatus can also provide the service a traditional Firewall provides, but in addition to several other features as described in this patent application. Hence the traditional firewall is a subset of this centralized firewall.

VCF Management:

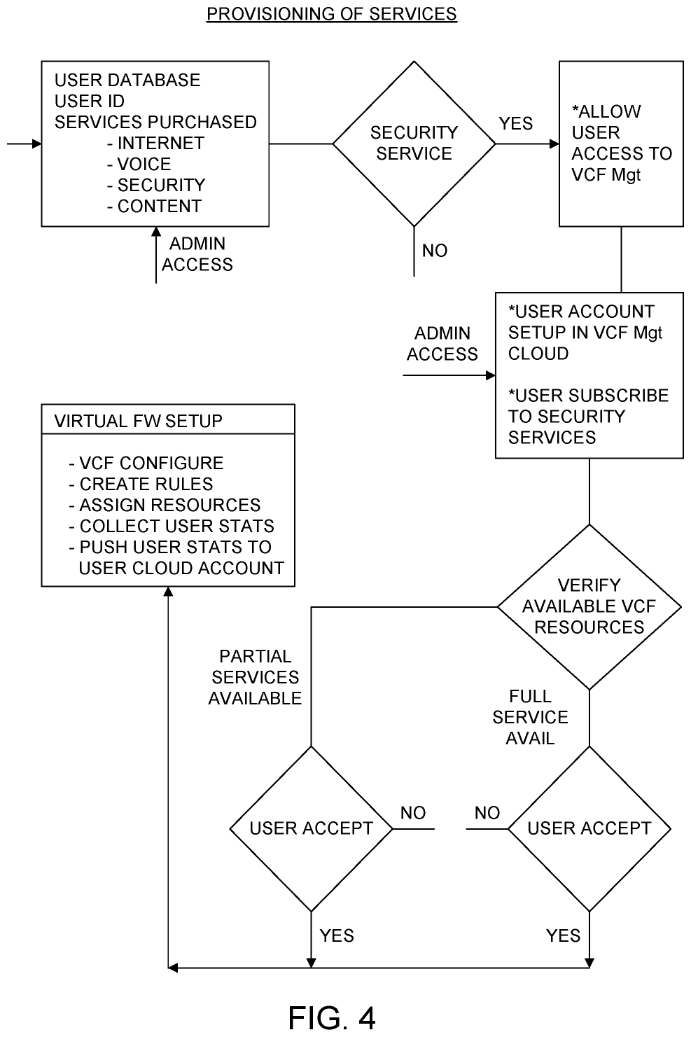

The configuration, management and monitoring of this Firewall device can be done from a cloud-based management application called the “VCF Management”. End users can login and connect to this management system to setup their account, subscribe to all or a subset of the services provided or opt out of all services offered anytime. Similarly, network administrators with special privileges can login and setup accounts for users and configure their services. Users can check the configuration, history and performance of just their portion of the firewall from their account. Administrators of the systems if allowed by pre-defined policies, can check the security history and identify and help the users having high amount of incoming or outgoing security threats. This is represented in FIG. 4.

Centralization and Virtualization

For all practical purposes, the VCF provides end users a Firewall as powerful as a dedicated local Firewall in their premises and all its functions at a minimum. Typically, it can provide a more powerful and sophisticated enterprise grade firewall due to the cost savings associated with the centralized location in addition to the management & configuration help available from the service provider. Users can manage their subscribed or assigned portion of the firewall resources as if a high-grade firewall is located in their local network and dedicated to them. Hence it is not only a centralized firewall but also a virtual Firewall from a user perspective. This also enables subscription-based security firewall services at full line speed of the network to the end users.

Note: Certain security features like special scans for certain data can be done in the cloud, but line speed Firewall in the cloud is not a practical option due the amount of bandwidth needed to send data up to cloud and bring back. Hence, implementing inline security virtualization in the cloud is not a practical solution currently for large amounts of data.

IoT Security: This device will provide security to IoT devices which typically do not have a virus scanner and much protection. In addition to the standard protection, the Firewall can be configured to control which IoT devices are allowed to communicate with which known destination devices on the internet. This protects the IoT devices from unauthorized access and hacking from the internet.

Features & Benefits:

1.) Cloud based control for configuration and monitoring of the entire system (VCF and cloud management) and all user accounts and their services by the administrator.

2.) Individual user control to setup his/her cloud account (for the VCF) and self-manage their portion of the VCF. Group user control to setup a group account and self-manage for the group.

3.) Product is designed with individual users or group-users as owners of their subscribed services, rather than treat entire set of users as one large group managed by a system admin (for a traditional firewall). This breakup combined with ability to assign resources and choose services from the firewall on an individual basis makes it a true virtualized Firewall from an end user perspective.

4.) Enables highly sophisticated and high-end Firewall accessible to ordinary users on subscription basis and pay just for the portion or resources needed, without having to purchase a Firewall that only Enterprises can afford. In short this provides Enterprise grade Firewall even to a small user without the upfront exorbitant cost.

5.) Cost and resource efficiency: Since a big powerful system is shared by multiple users and due to efficiencies of volume of users/data, this will cost the end user a fraction of the cost of purchasing a stand-alone home/SMB grade Firewall and still get a much superior service.

6.) Updating these Virus scanning tools, virus signature etc. can be done very quickly, remotely and as fast as top enterprises can do providing highest grade security.

7.) This solution will reduce the cost of Firewall equipment to about 10% (90% cost reduction) with faster response to new viruses and new types of cyber-attacks, thereby providing cost-effective safe internet to end users.

Features of Virtualized Centralized Firewall (VCF):

The Firewall is centralized replacing the end user firewalls. End user firewalls are all absorbed into one centralized firewall.

This is a Virtualized Firewall looking at the invention from the end user perspective.

The Centralized Firewall can be placed in the Headend, Cable Node, street side Cable cabinets, Telco Central offices, wireless cell towers including 5G towers (on or near), wireless tower feeder offices or any such places.

Individual user can manage services & resources assigned to him/her independently with privacy and security through his/her account. The user is assigned certain resources of the firewall during account setup and/or at subscription time.

End user can define, configure and modify the subscribed Firewall resources as required.

End user can monitor his/her cloud account and check the viruses scanned and deleted by the VCF and the threats faced and that were resolved along with any recommendation for safer internet use.

IoT security by blocking unauthorized access from outside the user network. Block IoT devices trying to access unauthorized devices outside the user network.

Technology applies to all broadband technologies like Cable, DSL, Fixed Wireless, mobile wireless broadband like LTE, 4G, 5G etc. or similar architectures.

All are labelled “prior art”, if any, is admitted prior art; art not labelled “prior art”, if any, is not admitted prior art. The illustrated embodiments, variations thereupon, and modifications thereto are provided for by the present invention, the scope of which is defined by the following claim.

What is claimed is:

1. A security system comprising a virtualized centralized firewall configured to be managed by an Internet Service Provider (ISP) and providing security services respectively to multiple customers of the ISP, each of the customers having access to manage the services provided to them.
